(19) United States
(12) Patent Application Publication
(10) Pub. No.: US 2014/0119245 A1
(43) Pub. Date: May 1, 2014

(54) SHARED LTE-ISM RF FRONT-END AND ANTENNA

(71) Applicant: BROADCOM CORPORATION, Irvine, CA (US)

(72) Inventor: Gabriel Desjardins, San Francisco, CA (US)

(73) Assignee: BROADCOM CORPORATION, Irvine, CA (US)

(21) Appl. No.: 13/706,313

(22) Filed: Dec. 5, 2012

Related U.S. Application Data
(60) Provisional application No. 61/721,388, filed on Nov. 1, 2012.

(51) Int. Cl. H04B 1/48

(52) U.S. Cl. CPC H04B 1/48
USPC 370/278

(57) ABSTRACT

A front-end module and antenna can be shared between two radio transceivers operating in coexistent radio frequency (RF) communication bands. For example, a first of the two radio transceivers may operate in one of a Long Term Evolution (LTE) band or an Industrial Scientific Medical (ISM) band, while a second of the two radio transceivers may operate in an alternative one of the LTE band and the ISM band. Use of a diplexer in the shared front-end module to pass RF signals between the two radio transceivers and the shared antenna can allow for sufficient isolation to avoid interference between transmit and receive operations in the coexistent RF communication bands.

### TECHNICAL FIELD

The technical field of the present disclosure relates to mobile wireless communication devices, and in particular, to combining an antenna and radio frequency (RF) front-end circuitry to provide shared Long Term Evolution (LTE) and Industrial Scientific Medical (ISM) band coverage.

### BACKGROUND

A wireless communication device, such as a cellular telephone, two-way radio, personal digital assistant (PDA), personal computer (PC), laptop computer, home entertainment equipment, radio frequency (RF) identification (RFID) reader, RFID tag, etc. may communicate directly or indirectly with other wireless communication devices. For direct communications (also known as point-to-point communications), the participating wireless communication devices may tune their receivers and transmitters to the same channel(s) (e.g., one of the plurality of RF carriers of a wireless communication system or a particular RF frequency for some systems) and communicate over that channel(s). For indirect wireless communications, a wireless communication device may communicate directly with an associated base station (e.g., for cellular services) and/or an associated access point (e.g., for an in-home or in-building wireless network) via an assigned channel. The base station/access point may then relay the communication to another wireless communication device either directly or through additional base stations/access points, etc. To complete a communication connection between the wireless communication devices, the associated base stations and/or associated access points may communicate with each other directly, via a system controller, the public switch telephone network, the Internet, and/or some other wide area network.

To participate in wireless communications, each wireless communication device may include a built-in radio transceiver (i.e., receiver and transmitter), or may be coupled to an associated radio transceiver (e.g., a station for in-home and/or in-building wireless communication networks, RF modem, etc.). In most applications, radio transceivers are implemented in one or more integrated circuits (ICs), which can be inter-coupled via traces on a printed circuit board (PCB). The transmitter can include a data modulation stage, one or more intermediate frequency (IF) stages, and a power amplifier (PA). The data modulation stage can be configured to convert raw data into baseband signals in accordance with a particular wireless communication standard. The one or more intermediate frequency stages can be configured to mix the baseband signals with one or more local oscillations to produce RF signals. The PA can be configured to amplify the RF signals prior to transmission via an antenna.

The receiver can be coupled to the antenna through an antenna interface and can include a low noise amplifier (LNA), one or more intermediate frequency stages, a filtering stage, and a data recovery stage. The LNA can be configured to receive inbound RF signals via the antenna and amplify them. The one or more IF stages can be configured to mix the amplified RF signals with one or more local oscillations to convert the amplified RF signal into baseband signals or IF signals. The filtering stage can be configured to filter the baseband signals or the IF signals to attenuate unwanted, out-of-band signals to produce filtered signals. The data recovery stage can then recover raw data from the filtered signals in accordance with the particular wireless communication standard.

Wireless communication systems may operate in accordance with different communication standards including, but not limited to: Institute of Electrical and Electronic Engineering (IEEE) 802.11 (e.g., WiFi™); Bluetooth®; advanced mobile phone services (AMPS); digital AMPS; global system for mobile communications (GSM); code division multiple access (CDMA); Long Term Evolution (LTE or 4G LTE); local multi-point distribution systems (LMDS); multi-channel-multi-point distribution systems (MMDS); RFID; and/or variations thereof. To communicate via these different communication standards, the aforementioned radio transceivers may operate in one or more bands, or portions of the radio communication frequencies spectrum

### BRIEF DESCRIPTION OF THE DRAWINGS

For a more complete understanding of example embodiments of the present invention, reference is now made to the following descriptions taken in connection with the accompanying drawings in which:

FIG. 1 is an exemplary block diagram representation of a communication system in which various embodiments devices employing multiple front-end and antenna configurations may be implemented

FIG. 2 is an exemplary schematic representation of a conventional multiple front-end and antenna configuration;

FIG. 3 is an exemplary schematic representation of a shared front-end and antenna configuration in accordance with various embodiments; and

FIG. 4 is a flow chart illustrating exemplary processes performed to implement a shared front-end and antenna configuration in accordance with various embodiments.

### DETAILED DESCRIPTION

In order to provide users the freedom to communicate, transmit and receive data, through various communication links and networks, wireless communication devices have evolved from utilizing, e.g., a single communication standard (and associated band(s)), to utilizing multiple radio transceivers and antennas that operate using multiple standards and multiple bands, e.g., dual-band, tri-band, and quad-band devices. For example, a cellular telephone may have traditional cellular voice capabilities by operating on, e.g., a GSM band or a CDMA band, while also having the ability to engage in Bluetooth® and WiFi™ communications.

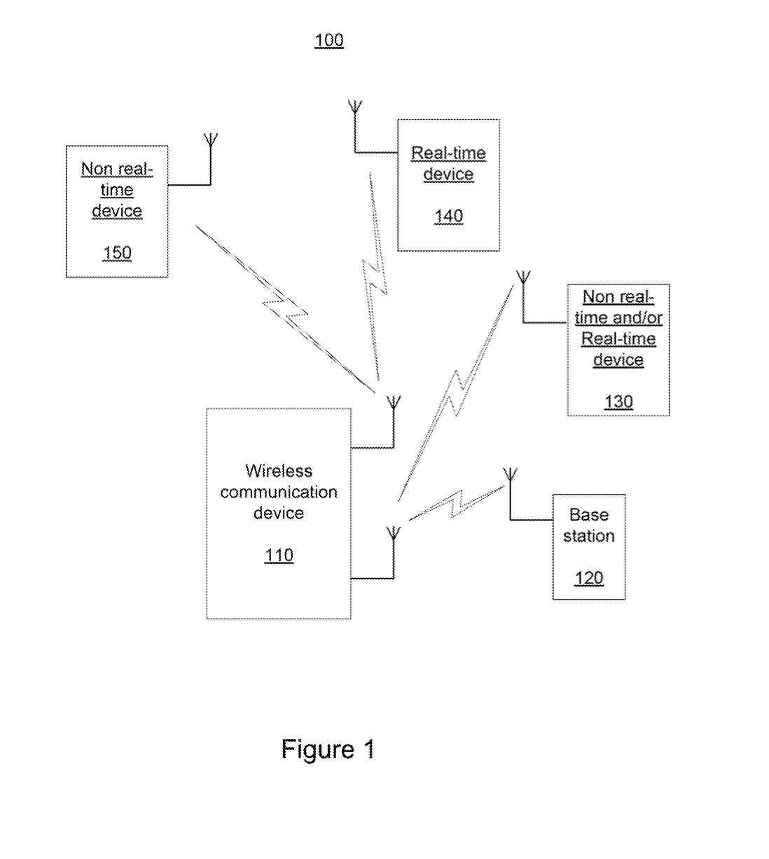

FIG. 1 illustrates an exemplary communication system in which various embodiments of the present disclosure may be implemented. In particular, wireless communication system 100 may include a wireless communication device 110 that can communicate real-time data and/or non-real-time data wirelessly with one or more other devices such as base station 120, non-real-time and/or real-time device 130, real-time device 140, and/or non-real-time device 150.

The wireless communication device 110 may communicate with the aforementioned other devices in accordance with one or more wireless standards/protocols, including, but not limited to the following: IEEE 802.11 (e.g., WiFi™); Bluetooth®; Ultra-Wideband (UWB); WIMAX; or other wireless network protocol; a wireless telephony data/voice protocol, such as GSM; General Packet Radio Service (GPRS); Enhanced Data Rates for Global Evolution (EDGE); Personal Communication Services (PCS); LTE; or other mobile wireless protocol or wireless communication protocol. Such wireless standards/protocols may be either standard or proprietary over one or more frequency bands such as the 800 MHz, 900 MHz, 2.3-2.69 GHz, 5.8 GHz, 60 GHz band, etc. The Bluetooth® operating band (2.402-2.48 GHz) and the WiFi™ operating band (2.401-2.495 GHz) are included within the Industrial Scientific Medical (ISM) band (2.4-2.5 GHz). The ISM band was traditionally reserved for industrial, scientific, and medical purposes other than communication, but now includes license-free communications, such as Bluetooth® and WiFi™.

It should be noted that wireless communication paths connecting the aforementioned devices to the wireless communication device 110 may include separate transmit and receive paths that use separate carrier frequencies and/or separate frequency channels. Alternatively, a single frequency or frequency channel can be used to bi-directionally communicate data to and from the wireless communication device 110.

Wireless communication device 110 may be a mobile phone, such as a cellular telephone, a PDA, game console, game device, PC, laptop computer, or other device that performs one or more functions that include communication of voice and/or data via a wireless communication path. The non-real-time and/or real-time, real-time, and non-real-time devices 130, 140, and 150 may be PCs, laptops, PDAs, mobile phones, such as cellular telephones, devices equipped with wireless local area network or Bluetooth® transceivers, FM tuners, TV tuners, digital cameras, digital camcorders, fixed and mobile location wireless communication stations such as base stations and wireless access points, or other devices that either produce, process or use audio, video signals or other data or communications.

In operation, the wireless communication device 110 may have implemented therein, one or more applications including, but not limited to: voice communications applications, such as standard telephony applications; voice-over-Internet Protocol (VoIP) applications; local gaming; Internet gaming; email; instant and short messaging; multimedia messaging; web browsing; printing; security; e-commerce; audio/video recording; audio/video playback; audio/video downloading; streaming audio/video playback; office applications, such as databases; spreadsheets; word processing; presentation creation and processing; and/or other voice and data applications. In conjunction with these applications, real-time data may include voice, audio, video, and/or multimedia applications including Internet gaming, etc. Non-real-time data may include text messaging, email, web browsing, file uploading and/or downloading, etc.

As illustrated in FIG. 1, wireless communication device 110 may include multiple antennas, in the example illustrated herein, two antennas. A consideration that arises when utilizing multiple antennas is isolation, i.e., ensuring that the antennas do not interfere with each other. Different methods of achieving isolation involve temporal isolation, spatial isolation, and/or frequency isolation. Temporal isolation may use time division multiplexing (TDM) to allow radios associated with the multiple antennas to take turns transmitting signals, while frequency isolation may involve “hopping” across a particular frequency band. In the case of spatial isolation, antennas in a multiple antenna wireless communication device are typically kept physically separate, i.e., at some distance away from each other, to effectuate isolation. Still other methods of addressing isolation involve active signal cancellation for cancelling interference signals.

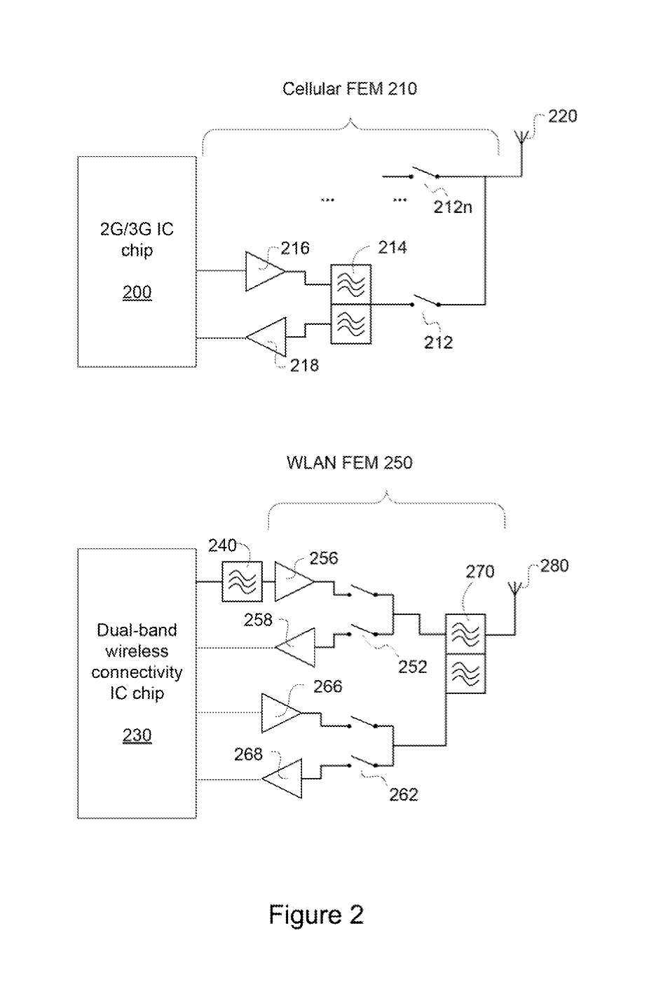

FIG. 2 illustrates an exemplary multiple antenna configuration, where a wireless communication device, such as wireless communication device 110 of FIG. 1, may include a 2G/3G IC chip 200 and a dual-band wireless connectivity IC chip 230. The aforementioned radio transceiver functionality for each communication standard may be implemented, respectively, in the 2G/3G integrated circuit (IC) chip 200 and its associated cellular front-end module (FEM) 210, and the dual-band wireless connectivity IC chip 230 and its associated WLAN FEM 250. An FEM or front-end circuitry refers, generally, to all the circuitry between an antenna and a first IF stage, i.e., all the components in a receiver that processes the signal at the original incoming RF, before it is converted to a lower IF. The wireless communication device 110 of FIG. 1 may further include a main cellular antenna 220 and a WLAN (e.g., 2.4 GHz and 5 GHz bands) antenna 280.

The cellular FEM 210 can include one or more switches 212-212n, for controlling main cellular antenna 220 access for radio signals associated with multiple bands, where n refers to a number of frequencies supported by the cellular FEM 210. The cellular FEM 210 can further include a duplexer 214, LNA 216, and PA 218 for effectuating communications on a first of the supported frequencies/bands, where additional like elements can be implemented for other communication bands.

The WLAN FEM 250 can include circuitry, in this instance, for communications in the 2.4 GHz and 5 GHz bands, where a diplexer 270 can be utilized for frequency domain multiplexing allowing usage of the WLAN antenna 280 for transmitting and receiving signals in both the 2.4 GHz and 5 GHz bands. In this instance, switch 252 can be configured to toggle between transmit (WLAN PA 256 and filter 240) and receive (WLAN LNA 258) circuitry in the 2.4 GHz band, and switch 262 can be configured to switch between transmit (WLAN PA 266) and receive (WLAN LNA 268) circuitry in the 5 GHz band. It should be noted that in certain embodiments, the WLAN FEM 250 may be thought of as being made up of separate FEMs, e.g., a 2.4 GHz FEM and a 5 GHz FEM.

As previously described, wireless communication may be effectuated in accordance with the LTE standard. The LTE standard evolved from the GSM/EDGE and Universal Mobile Telecommunications System (UMTS)/High Speed Packet Access (HSPA) network technologies, and increases the capacity and speed of communications by using a different radio interface together with core network improvements. Although upgrading to LTE is a natural extension for GSM/UMTS networks, even CDMA-based networks are migrating to the LTE standard. There are various frequency bands that are being/have been designated for use with LTE, which supports both time division duplexing (TDD) which relies on a single band for uplink (UL) and downlink (DL) transmissions, and frequency division duplexing (FDD) which requires a pair of bands for UL and DL transmission. Certain LTE bands, e.g., LTE Band 40 (supporting TDD in the 2.3-2.4 GHz range), LTE Band 7 (supporting the FDD UL and DL transmission in the 2.5-2.57 GHz and 2.62-2.69 GHz ranges), eXtended Global Platform (XGP)/LTE Band 38 (supporting TDD in the 2.57-2.62 GHz range), and LTE Band 41 (supporting TDD in the 2.496-2.69 GHz range) are adjacent to/coexistent with the aforementioned ISM band.

A popular wireless communication device configuration may have one or more cellular LTE communication bands that can be supported along with Bluetooth® and WiFi™, both working in the ISM band. When operating simultaneously, the radios that support each communication band do so in adjacent frequencies that may result, for example, in an LTE band radio transmitting signals interfering with an ISM band radio receiving signals, and vice versa. Depending on the amount of separation between the adjacent frequencies, a certain amount of isolation may be desired to minimize interference between the coexisting LTE and ISM bands. For example, a desired level of isolation may be 15 dB.

As a result of implementing multiple front-end modules/circuitry and multiple antennas to handle multi-band communications in a wireless communication device, the construction of such wireless communication devices can be a challenge to designers that wish to simplify their designs, make them more efficient, smaller, etc. For example, and as a consequence of designing wireless communication devices around multiple antenna configurations, wireless communication devices may end up being “built around” physically separated antennas. Having to accommodate multiple antennas and a desired orientation of those antennas may force designers to sacrifice antenna isolation for a smaller device size or vice versa.

Various embodiments are directed to systems and methods for providing desired isolation in order to eliminate interference in wireless communications devices associated with antennas operative in coexisting RF communication bands, e.g., the LTE and ISM bands. To effectuate this isolation, FEMs/circuitry can be shared between radio transceivers supporting communications over different bands, e.g., an LTE IC chip and a chip supporting communications in the ISM bands. To share the FEMs/circuitry, a diplexer can be configured to multiplex signals on two ports (i.e., signaling from the LTE IC chip and signaling from the ISM band chip) onto a third port, to which a shared LTE-ISM antenna can be connected. Therefore, the diplexer can be configured to allow the LTE IC chip signals and the ISM band chip signals to coexist on the third port without interfering with each other.

A diplexer is a passive device generally utilized to implement frequency domain multiplexing. In accordance with various embodiments, a diplexer can be used to implement frequency domain multiplexing with respect to an LTE IC chip and an ISM band chip. That is, and as alluded to previously, the diplexer may have a first port through which LTE band signaling can be passed, and a second port through which ISM band signaling can be passed. The LTE band and ISM band signaling can be multiplexed onto a third port to which a shared LTE-ISM band antenna can be connected. When receiving LTE band and ISM band signaling via the shared LTE-ISM antenna, the signals can be received at the third port and demultiplexed accordingly.

It should be noted that a diplexer is a passive circuit element that differs from a passive combiner or splitter, which may be utilized in conventional shared antenna configurations. That is, the ports of a diplexer are generally frequency selective, whereas the ports of a combiner generally are not. Additionally, a passive combiner or splitter generally will equally divide received power between its radio ports. It should be further noted that a diplexer may combine a relatively wide bandwidth of frequencies, its limitations arising from the ability of the antenna to handle wide bandwidths. However, a diplexer may be utilized in accordance with various embodiments to, as discussed previously, multiplex signals from adjacent bands, negating such limitations.

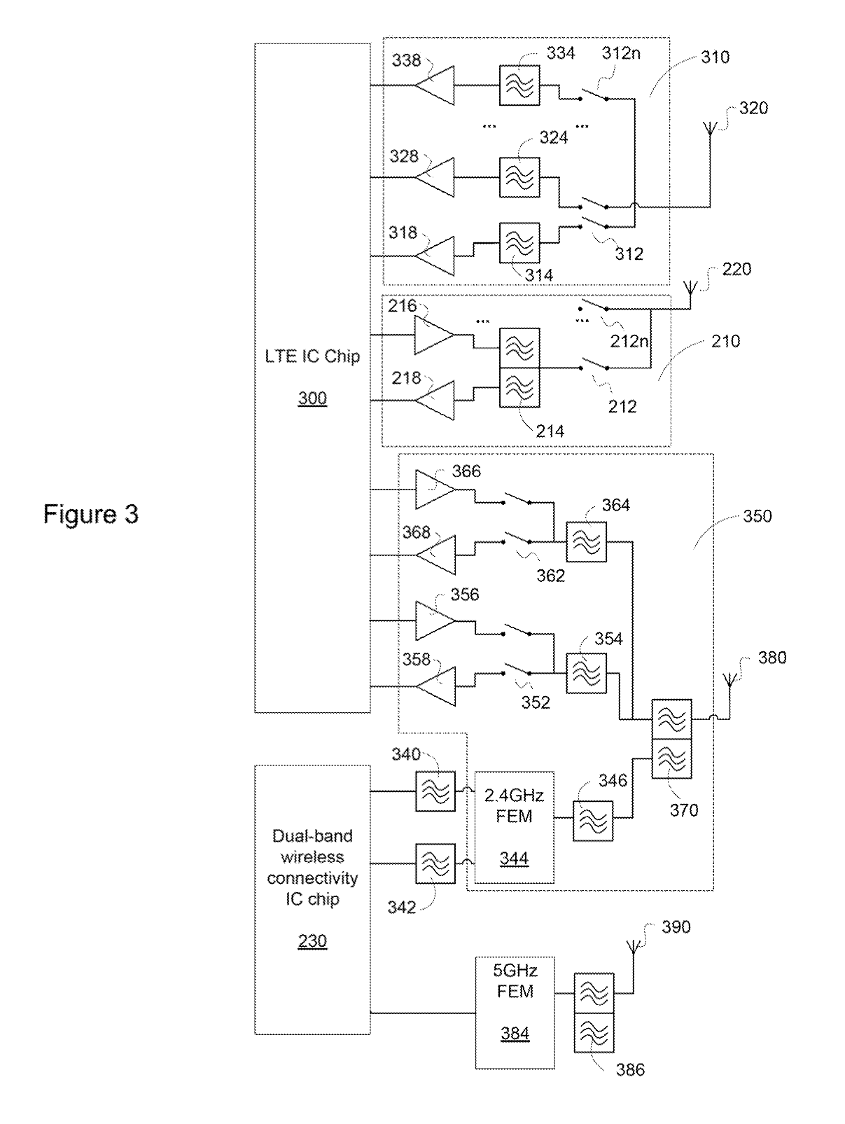

FIG. 3 illustrates an exemplary shared front-end and antenna configuration for handling coexisting LTE and ISM band communications with a desirable level of isolation in a wireless communication device. For example, and in accordance with some embodiments, a level of isolation that meets or even exceeds 15 dB may be achieved. In this exemplary configuration, a wireless communication device may employ an LTE IC chip 300 and an ISM band chip, such as a dual-band wireless connectivity IC chip 230, to effectuate radio transceiver functionality in one or more LTE and ISM bands. A cellular FEM 210 can be associated with the LTE IC chip 300 including one or more switches 212-212n, for controlling access to a main cellular antenna 220 for radio signals associated with multiple cellular bands, where n refers to a number of supported frequencies. The cellular FEM 210 may also include a duplexer 214, LNA 216, and PA 218 for effectuating communications on a first of the supported frequencies/bands, where additional like elements may be implemented for other cellular communication bands.

Additionally, the LTE IC chip 300 can be associated with a receive diversity (R×D) FEM 310, and an R×D LTE antenna 320, access to which can be controlled by switches 312-312n. Reception filters 314, 324, and 334 can be utilized as bandpass filters, and operate in conjunction with respective LNAs 318, 328, and 338 for receiving data in a plurality of LTE frequency bands, e.g., LTE Band 40, XGP/LTE Band 38, etc. It should be noted that the use of more receiver or transmitter antennas can be referred to as multiple-input and multiple-output (MIMO). MIMO refers to a form of smart antenna technology that can be utilized for increasing data throughput and link range without additional bandwidth or increased transmit power by spreading transmit power over antennas, thereby achieving an array gain or diversity gain that may improve link reliability/channel fading.

In accordance with various embodiments, FEM/circuitry 350 can be shared between the LTE IC chip 300 and the dual-band wireless connectivity IC chip 230. The FEM /circuitry 350 can include PAs 356 and 366 for amplifying LTE frequency band signals, e.g. LTE Band 40 and/or XGP/LTE Band 38 signals prior to transmission, and LNAs 358 and 368 for amplifying received inbound LTE frequency band signals, e.g. LTE Band 40 and/or XGP/LTE Band 38 signals. Access to a shared LTE-ISM antenna 380 can be controlled via switches 352 and 362, where in FIG. 3, switches 352 and 362 may be single pole double throw switches configured for transmit-receive switching purposes with the shared LTE-ISM antenna 380. Between the shared LTE-ISM antenna 380 and the switches 352 and 362, can be bandpass filters 354 and 364 and a diplexer 370, which will be discussed in greater detail. The FEM/circuitry 350 may further include the functionality of a 2.4 GHz band FEM (such as that described for the WLAN front-end 250 illustrated in FIG. 2) in FEM 344. As with the LTE portion of the FEM/circuitry 350, a bandpass filter 346 and the diplexer 370 may reside between the FEM 344 and the shared LTE-ISM antenna 380. Filters 342 and 340 may provide optional bandpass filtering to enhance filtering in the diplexer 370.

Use of the diplexer 370 in accordance with various embodiments can allow the adjacent/coexistent frequencies of the LTE and ISM bands to be handled with sufficient isolation, by design, thereby exploiting this adjacent/coexistent aspect of the LTE and ISM bands. The diplexer 370 can be configured to receive and transmit signaling in the LTE band (e.g., LTE bands 38 and 40) through a first port, while receiving and transmitting signaling in the WLAN band (e.g., 2.4 GHz band) through a second port. A third port of the diplexer 370 can connect to the shared LTE-ISM antenna 380, allowing for multiplexing and demultiplexing the LTE and ISM band signals accordingly without interference.

It should be noted that in accordance with other embodiments, other LTE and ISM band combinations may be supported. For example, the 2.4 GHz WLAN band may be combined with any of the LTE bands 38, 7, 40, or 41. Additionally, a shared antenna may be utilized to only cover signaling between 2.3 GHz and 2.7 GHz instead of utilizing the shared antenna to cover signaling in the full 700 MHz to 20 GHz range, if such LTE and ISM bands were combined with cellular band signaling.

It should be further noted that N number of bands may be combined in accordance with other embodiments, where the number of bands may be multiplexed with an appropriate device. For example, a triplexer may utilized to combine three bands/sets of bands. That is, XGP/LTE Band 38, LTE Band 7, LTE Band 41 may be “bundled” together and handled by a first portion of a shared FEM, LTE Band 40 may be handled by a second portion of the shared FEM, and the 2.4 GHz WLAN band may be handled by a third portion of the shared FEM. The triplexer may connect to a shared antenna capable of operation in all of these bands, and may be utilized in a manner similar to the diplexer described previously, to multiplex/demultiplex signals transmitted and received by the shared antenna.

The dual-band wireless connectivity IC chip 230 may further include a 5 GHz band FEM 384 to effectuate communications in the 5 GHZ WLAN band, a diplexer 386, and an antenna 390. It should be noted that the antenna 390 may be configured as another shared LTE-ISM antenna, while the diplexer 386 may be configured to multiplex/demultiplex, e.g., 5 GHz WLAN signals and signals in another LTE band, for example, LTE Band 7, in a similar manner to that described previously. Such a configuration may be useful if it is found, for example, that the diplexer 370 is not “sharp” enough to cover LTE Band 7 (UL and DL portions of LTE Band 7 fall between/adjacent to LTE bands 38 and 40). Alternatively, the antenna 390 may be configured just for operation in the 5 G WLAN band alone. Again, desired isolation may be achieved by such a design in accordance with various embodiments.

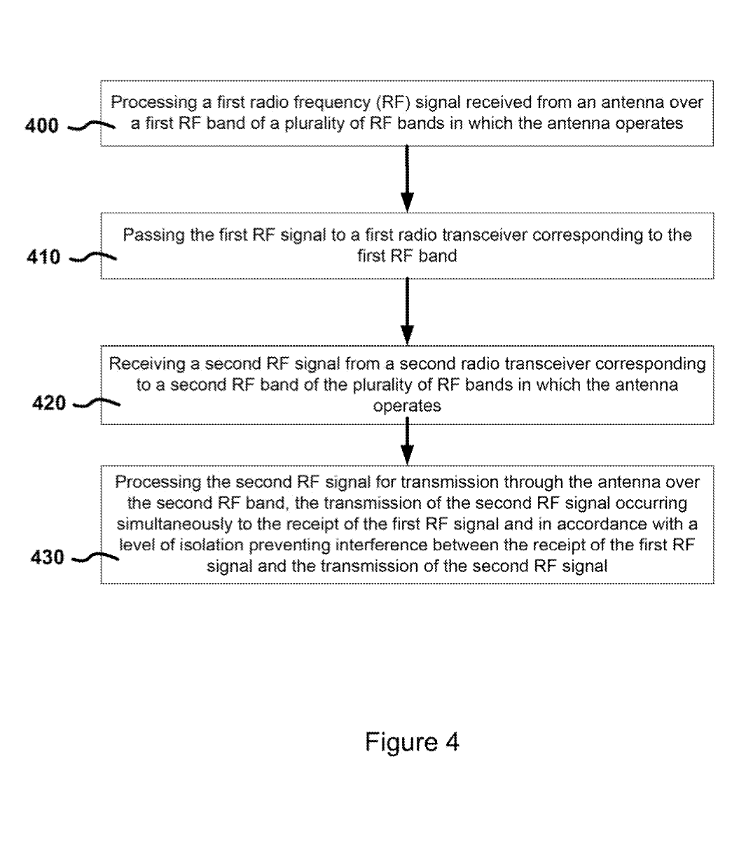

FIG. 4 illustrates exemplary processes that may be performed during operation of a shared LTE-ISM front-end and antenna in accordance with various embodiments. A first RF signal received from an antenna over a first RF band of a plurality of RF bands in which the antenna operates can be processed (400). For example, the antenna may be operative in the LTE band and the ISM band, and the first RF band may be received over an LTE band, such as LTE Band 38 or 40, or an ISM band, e.g., the WiFi™ operating band. The first RF signal can be passed to a first radio transceiver corresponding to the first RF band (410). That is, if the first RF signal was received, as described, over an LTE band, the first RF signal can be passed to a corresponding LTE band radio transceiver. A second RF signal can be received from a second radio transceiver corresponding to a second RF band of the plurality of RF bands in which the antenna operates (420). In this example, the first RF signal was received over an LTE band, and therefore, by way of example, the second RF signal may correspond to the ISM band. The second RF signal can be processed for transmission through the antenna over the second RF band (in this instance, the ISM band), where transmission of the second RF signal may occur simultaneously to the receipt of the first RF signal (over the LTE band). The transmission and receipt of the first and second RF signals can be done with a desired level of isolation that prevents interference between the receipt and transmission of the first and second RF signals (430).

While various embodiments of the present disclosure have been described above in the context of a wireless communication device operative in adjacent LTE and ISM bands, it should be understood that they have been presented by way of example only, and not of limitation. For example, the systems and methods described herein may be applied to the same or other communication standards operative in adjacent or otherwise coexistent frequency bands, such as certain LTE and Global Navigation Satellite Systems (GNSS) bands. It should be further understood that more or less circuitry, elements, such as radios, filters, switches, etc. may be implemented in a wireless communication device to effectuate communications over a variety of standards, protocols, etc. in accordance with various embodiments.

Likewise, the various diagrams may depict an example architectural or other configuration for the various embodiments, which is done to aid in understanding the features and functionality that can be included in embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus, comprising:
a first radio transceiver associated with front-end circuitry operative in a first frequency band;
a second radio transceiver operative in a second frequency band coexistent with the first frequency band, and sharing the front-end circuitry;
a diplexer for effectuating the sharing of the front-end circuitry; and
an antenna connected to the diplexer, and configured to transmit and receive radio frequency (RF) signals for the first and second radio transceivers in the first and second frequency bands.

2. The apparatus of claim 1, wherein the first frequency band comprises an Industrial Scientific Medical (ISM) band operative between 2.4 GHz and 2.5 GHz.

3. The apparatus of claim 1, wherein the second frequency band comprises a Long Term Evolution (LTE) band operative between 2.3 GHz and 2.62 GHz.

4. The apparatus of claim 1, wherein the diplexer comprises a passive circuit element having first and second ports connected, via the front-end circuitry, to the first and second radio transceivers, respectively, and a third port connected to the antenna.

5. The apparatus of claim 1, wherein the front-end circuitry comprises:
at least one power amplifier configured to amplify a first RF signal for transmission via the antenna in the first frequency band, the first RF signal being created from a first baseband signal generated by the first radio transceiver; and
at least one low noise amplifier configured to amplify a second RF signal received at the antenna in the first frequency band for conversion into a second baseband signal by the first radio transceiver.

6. The apparatus of claim 1, wherein the front-end circuitry comprises:
at least one power amplifier configured to amplify a first RF signal for transmission via the antenna in the second frequency band, the first RF signal being created from a first baseband signal generated by the second radio transceiver; and
at least one low noise amplifier configured to amplify a second RF signal received at the antenna in the second frequency band for conversion into a second baseband signal by the second radio transceiver.

7. The apparatus of claim 1, wherein a first RF signal transmitted via the antenna and a second RF signal received via the antenna are isolated from each other at a level greater than or equal to 15 dB.

8. The apparatus of claim 7, wherein the first RF signal is transmitted via the antenna over the first frequency band, and the second RF signal is received via the antenna over the second frequency band.

9. The apparatus of claim 7, wherein the first RF signal is transmitted via the antenna over the second frequency band, and the second RF signal is received via the antenna over the first frequency band.

10. A computer program product, embodied on a non-transitory computer-readable medium, comprising:
computer code for producing a first RF signal at a first radio transceiver;
computer code for receiving a second RF signal from an antenna;
computer code for passing the first RF signal to the antenna for transmission, through a front-end module and a diplexer, and passing the second RF signal from the antenna through the diplexer and the front-end module to a second radio transceiver, the front-end module being shared between the first and second radio transceivers, and wherein the transmission of the first RF signal and the receipt of the second RF signal are isolated from each other.

11. The computer program product of claim 10 further comprising, computer code for transmitting the first RF signal in a first frequency band comprising an Industrial Scientific Medical (ISM) band operative between 2.4 GHz and 2.5 GHz.

12. The computer program product of claim 10 further comprising, computer code for receiving the second RF signal is received in a second frequency band comprising a Long Term Evolution (LTE) band operative between 2.3 GHz and 2.62 GHz.

13. The computer program product of claim 10 further comprising:
computer code for amplifying, via at least one power amplifier, the first RF signal for transmission via the antenna in the first frequency band; and
computer code for amplifying, via at least one low noise amplifier, the second RF signal received at the antenna in the first frequency band.

14. The computer program product of claim 13 further comprising:
computer code for creating the first RF signal from a first baseband signal generated by the first radio transceiver; and
computer code for converting, in the first radio transceiver, the second RF signal received at the antenna to a second baseband signal.

15. The computer program product of claim 10, wherein the front-end circuitry comprises:
computer code for amplifying, via at least one power amplifier, the first RF signal for transmission via the antenna in the second frequency band; and
computer code for amplifying, via at least one low noise amplifier, the second RF signal received at the antenna in the second frequency.

16. The computer program product of claim 14 further comprising:
computer code for creating the first RF signal from a first baseband signal generated by the second radio transceiver; and
computer code for converting, in the second radio transceiver, the second RF signal received at the antenna to a second baseband signal.

17. The computer program product of claim 10, wherein a level of the isolation between the transmission of the first RF signal and the receipt of the second RF signal is greater than or equal to 15 dB.

18. A method, comprising:
processing a first radio frequency (RF) signal received from an antenna over a first RF band of a plurality of RF bands in which the antenna operates;
passing the first RF signal to a first radio transceiver corresponding to the first RF band;
receiving a second RF signal from a second radio transceiver corresponding to a second RF band of the plurality of RF bands in which the antenna operates; and
processing the second RF signal for transmission through the antenna over the second RF band, the transmission of the second RF signal occurring simultaneously to the receipt of the first RF signal and in accordance with a level of isolation that prevents interference between the receipt of the first RF signal and the transmission of the second RF signal.

19. The method of claim 18, wherein the first RF band comprises an Industrial Scientific Medical (ISM) band operative between 2.4 GHz and 2.5 GHz, and wherein the second RF band comprises a Long Term Evolution (LTE) band operative between 2.3 GHz and 2.62 GHz.

20. The method of claim 18 further comprising one of:
receiving a third RF signal from the second radio transceiver corresponding to a third RF band of the plurality of RF bands in which the antenna operates, and processing the third RF signal for transmission through the antenna over the third RF band, the transmission of the third RF signal occurring simultaneously to the receipt of the first RF signal and the transmission of the second RF signal, and in accordance with the level of isolation that further prevents interference between the receipt of the first RF signal, the transmission of the second RF signal, and the transmission of the third RF signal; or
processing a fourth RF signal received from the antenna over a fourth RF band of the plurality of RF bands in which the antenna operates, and passing the fourth RF signal to the second radio transceiver that further corresponds to the fourth RF band, the receipt of the fourth RF signal occurring simultaneously to the receipt of the first RF signal and the transmission of the second RF signal, and in accordance with the level of isolation that further prevents interference between the receipt of the first RF signal, the transmission of the second RF signal, and the receipt of the fourth RF signal.
